(19) United States
(12) Patent Application Publication
(10) Pub. No.: US 2014/0353261 A1
(43) Pub. Date: Dec. 4, 2014

(54) KCR SCREEN CHANGER

(71) Applicant: Parkinson Machinery & Manufacturing, Woonsocket, RI (US)

(72) Inventors: Kenneth M. Cavanagh, Warwick, RI (US); John Whaley, North Kingstown, RI (US)

(21) Appl. No.: 13/903,276

(22) Filed: May 28, 2013

(51) Int. Cl. B01D 33/00

(52) U.S. Cl. CPC B01D 33/0067
USPC 210/783; 210/391; 210/396

(57) ABSTRACT

A screen changer for filtering a thermoplastic material heated to a flowable state comprises a filter head defining a melt passage for the heated thermoplastic material, and a guide channel having entry and exit sections arranged on opposite sides of the melt passage. The entry and exit sections are configured and arranged to direct a continuous screen filter along a guide path extending transversely across the melt passage from an entry side to an exit side of the filter head. The screen filter is incrementally advanced along the guide path. An internal first cavity is provided in the filter head on an upstream side of the filter screen and at a juncture of the melt passage and the exit section of the guide channel. The first cavity is positioned to receive contaminants accumulated on the screen filter. A waste removal mechanism removes contaminants from the first cavity.

### FIELD OF THE INVENTION

This invention relates to continuous screen changers for filtering contaminants from melt flows of thermoplastic materials.

### BACKGROUND

In one type of known screen changer, the inlet and exit blocks are permanently water cooled. A solidified plug of polymer is formed on the screen extending through the exit block. The screen is moved by heating the exit block to allow movement of the solidified polymer plug, taking with it the dirty screen and pulling a fresh clean section of the screen across the melt flow passage. With this design, the ability to react rapidly to needed screen advancement is adversely delayed by the time required to reheat the solidified polymer plug. In another type of known screen changer, the screen is specially designed with longitudinally spaced transverse seals. The seals serve to prevent molten polymer from escaping through the inlet and exit sections of the screen guide channel. Experience has shown that this design is suitable for filtering some but not all polymers.

In another type of screen changer, as disclosed in PCT application no. PCT/US13/33654, filed Mar. 25, 2013, a filter housing defines a melt passage for the thermoplastic material being filtered. A guide channel in the housing is configured and arranged to direct a continuous screen filter across the melt passage. A gate blocks the exit section of the guide channel during initial formation of a solidified plug of the material being filtered on the screen filter. The gate is then partially withdrawn to an intermediate position at which it acts as a brake to releasably impede movement of the plug and screen filter until a screen change is required. The gate is then fully withdrawn and the screen filter and the plug formed thereon is pulled across the melt passage by an exterior clamp mechanism. While this type of screen changer is an improvement over prior designs, experience has shown that in some applications, where the melt stream is contaminated with larger particles, including for example nails and other like metallic inclusions, the guide channel may become blocked, preventing withdrawal of the screen filter, and necessitating a complete shutdown of the filtering process while the screen changer is dismantled in order to gain access to the stalled screen filter.

### SUMMARY OF THE INVENTION

Broadly stated, the objective of the present invention is to provide an improved screen changer that is free of the drawbacks associated with the above described known designs.

In accordance with an exemplary embodiment of the present invention, a filter head defines a melt passage for heated thermoplastic material, and further defines a guide channel having entry and exit sections arranged on opposite sides of the melt passage. The entry and exit sections of the guide channel are configured and arranged to direct a continuous screen filter along a path extending transversely across the melt passage from an entry side to an exit side of the filter head.

A pulling mechanism provides a means for incrementally advancing the screen filter across the melt passage.

An internal first cavity is provided in the filter head on an upstream side of the screen filter, and at a juncture of the melt passage and the exit section of the guide channel. The first cavity is positioned to receive contaminants that have accumulated on the upstream side of the screen filter as the screen filter is advanced by the pulling mechanism.

A waste removal means serves to remove contaminants from the first cavity.

In a preferred exemplary embodiment of the present invention, the waste removal means comprises a cylindrical plug journalled for rotation in the filter head at a location adjacent to the first cavity. The cylindrical plug defines a second cavity, and a first operating mechanism serves to rotate the plug between a first position at which the second cavity communicates with and receives contaminants from the first cavity, and a second position at which the second cavity is isolated from the first cavity and aligned with an outlet in the filter head through which the contaminants may be expelled from the second cavity.

These and other features and attendant advantages of exemplary embodiments of the present invention will now be described in further detail with reference to the accompanying drawings, wherein:

### BRIEF DESCRIPTION OF THE DRAWINGS

FIG. 1 is a front perspective view of a screen changer in accordance with an exemplary embodiment of the present invention;

FIG. 2 is a rear view of the screen changer shown in FIG. 1;

FIG. 3 is an end view looking from right to left in FIG. 1;

FIG. 4 is a horizontal cross section on an enlarged scale taken through the filter head;

FIG. 5A-5C are partial sectional views showing sequential stages in the operation of a waste removal means in accordance with a preferred exemplary embodiment of the present invention;

FIG. 6 is an exploded perspective view of selected components of the waste removal means;

FIG. 7 is an assembled perspective view of the components of the waste removal means depicted in FIG. 6;

FIG. 8 is a view similar to FIGS. 5A-5C showing the second cavity occupied by the ejector rod;

FIG. 9 is a diagrammatic illustration of the screen pulling mechanism; and

FIG. 10 is a diagrammatic illustration of an alternative waste removal means.

### DETAILED DESCRIPTION

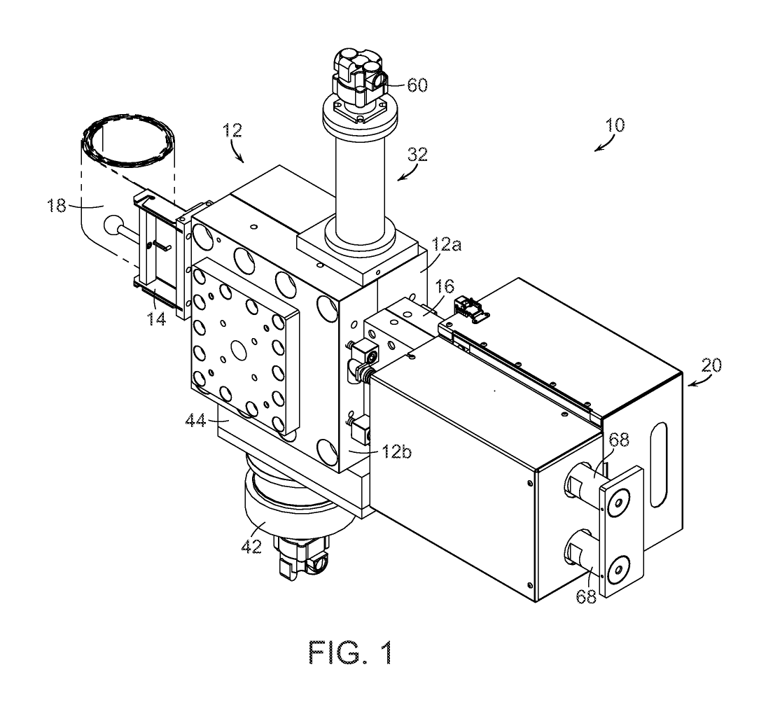

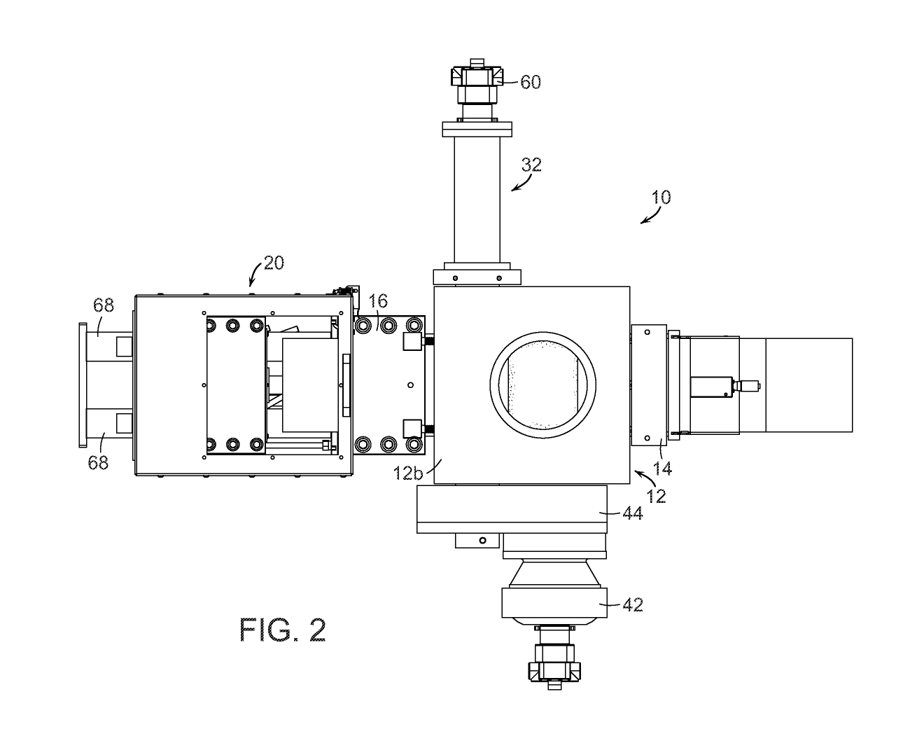

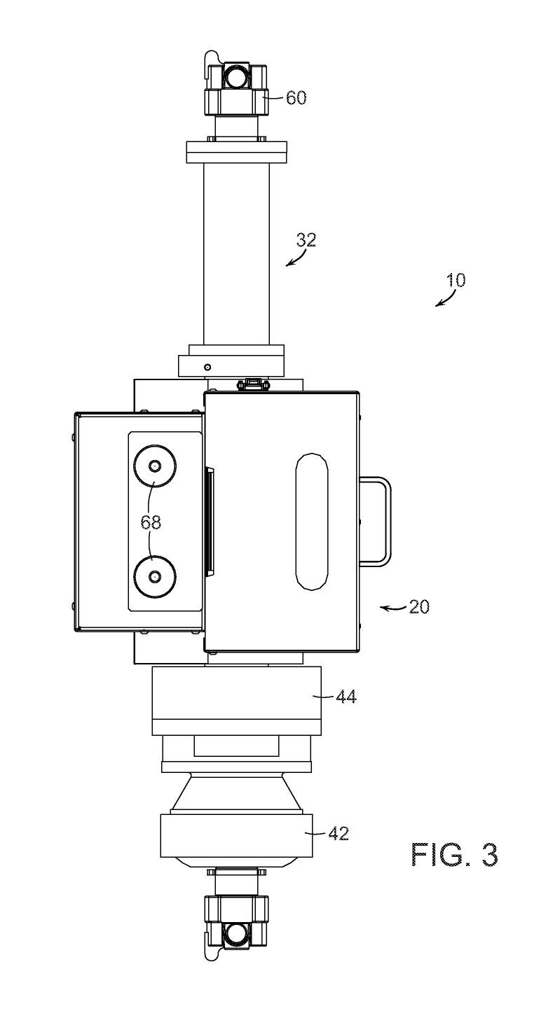

With reference initially to FIGS. 1-3, a screen changer in accordance with an exemplary embodiment of the present invention is generally depicted at 10. The screen changer comprises a filter head 12 subdivided into upstream and downstream halves 12a, 12b. Entry and exit guides 14, 16 direct a continuous screen filter 18 into and out of the filter head 12. A pulling mechanism 20 attached to the exit guide 16 provides a means for incrementally advancing the screen filter.

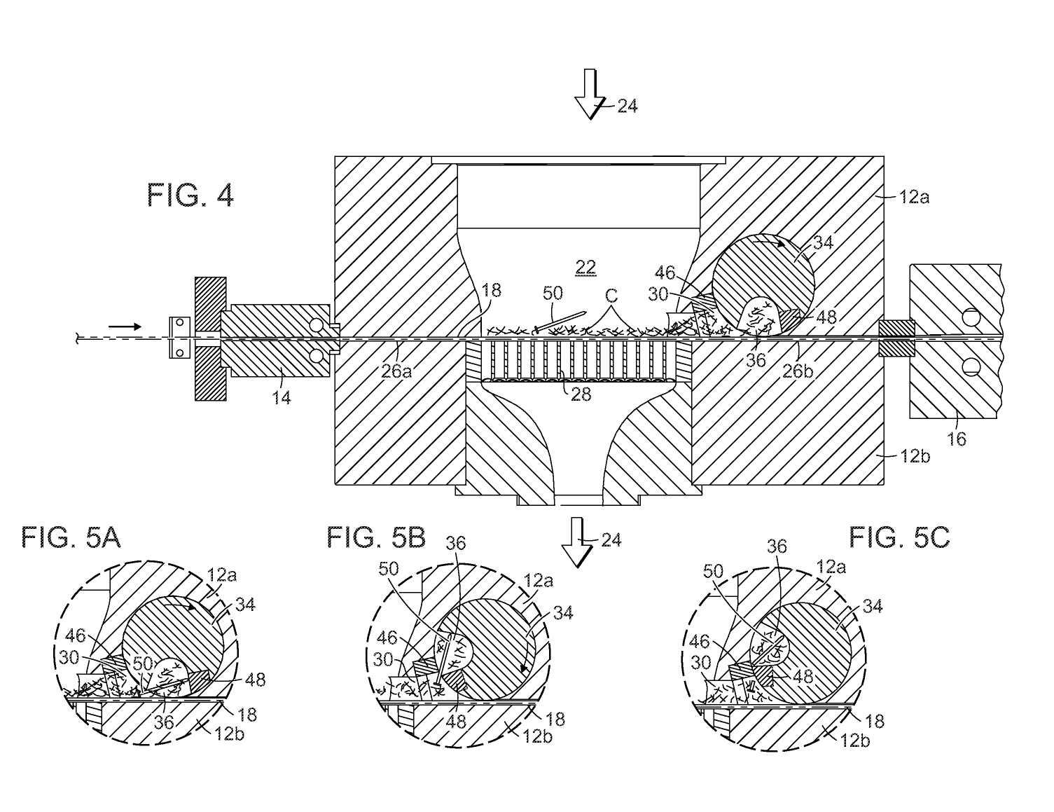

As shown in FIG. 4, the filter head defines a melt passage 22 for the heated thermoplastic material entering and exiting from the filter head in the direction indicated diagrammatically by arrows 24. A guide channel has entry and exit sections 26a, 26b arranged on opposite sides of the melt passage 22. The entry and exit sections 26a, 26b of the guide channel are configured and arranged to direct the screen filter 18 along a path extending transversely across the melt passage 22 from an entry side to an exit side of the filter head. A perforated breaker plate 28 provides support for the segment of the screen filter extending across the melt passage.

An internal first cavity 30 is provided in the filter head 12 on an upstream side of the screen filter 18 and at a juncture of the melt passage 22 and the exit section 26b of the guide channel. The first cavity is positioned to receive contaminants “C” accumulating on the screen filter 18.

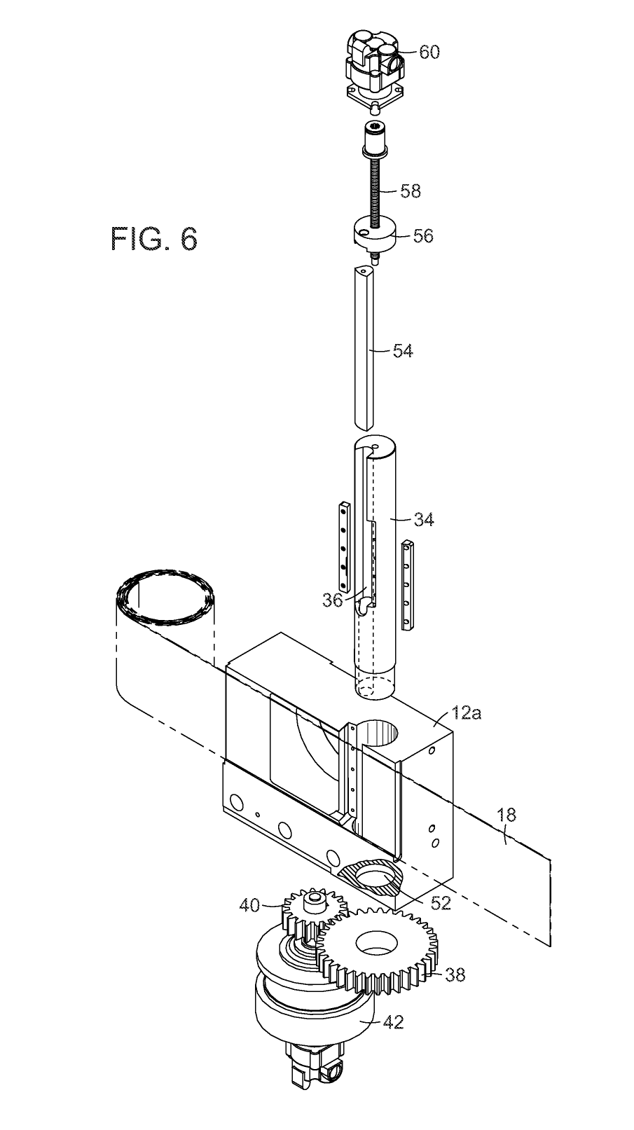

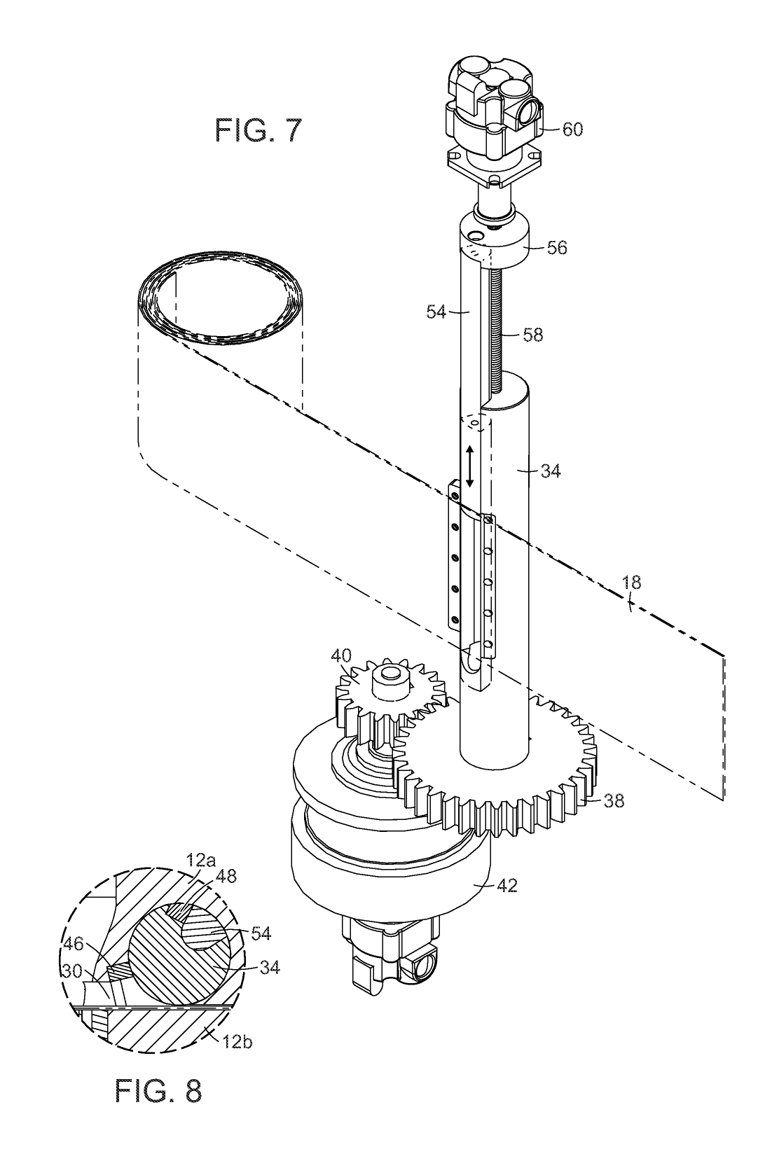

A waste removal means generally depicted at 32 in FIGS. 1-3 serves to remove contaminants from the first cavity 30. With reference additionally to FIGS. 6 and 7, it will be seen that the waste removal means comprises a cylindrical plug 34 journalled for rotation in the filter head 12 at a location adjacent to the first cavity 30. The plug 34 has an open sided elongated second cavity 36. The plug 34 is connected to and rotatively driven by a gear 38 meshed with a pinion 40 on the output shaft of a motor 42. The gear 38 and pinion 40 are contained in a gear box 44 secured to the underside of the filter head.

A bed knife 46 is provided on an edge of the first cavity 30, and a shear knife 48 is provided on an edge of the second cavity 36.

As depicted in FIG. 4, during the filtering process, contaminants C in the melt stream gradually accumulate on the upstream side of the screen filter 18. The contaminants may include a variety of particulates, including for example nails 50 and other like metallic debris. As the screen filter is advanced by the pulling mechanism 20, and as shown in FIG. 5A, contaminants received in the first cavity 30 will progress into the second cavity 36. In some cases, debris such as the nail 50 will be trapped between the screen filter 18 and the interior of the second cavity.

When the time comes to purge contaminants received in the second cavity 36, the plug 34 is rotated to the position shown in FIG. 5C to thereby isolate the second cavity 36 from the first cavity 30. In the course of such rotation, and as shown in FIGS. 5B and 5C, trapped nails or other like debris will be sheared by the shear knife 48 acting in concert with the bed knife 46.

When the plug 34 has been rotated to the position shown in FIG. 5C, the second cavity 36 is aligned vertically with a waste removal port 52 (see FIG. 6) in the bottom of the upstream half 12a of the filter head 12.

Again with reference to FIGS. 6 and 7, contaminants are expelled from the second cavity 36 through the waste removal port 52 by means of an ejector rod 54 mounted for reciprocal movement in the second cavity. The ejector rod 54 is connected to a nut 56 threaded on a screw 58 rotatably driven by a motor 60. Rotating the screw 58 in one direction will cause the nut 56 and ejector rod 54 to be driven downwardly into the second cavity 36, with the ejector rod filling the second cavity (see FIG. 8) and thereby expelling contaminants through waste removal port 52.

After contaminants have been expelled from the second cavity 36 and the plug 34 has been returned to its first position (as shown in FIGS. 4 and 5A), the screw 58 may be rotated in the opposite direction to gradually withdrawn the ejector rod 54 from the second cavity 36, thereby allowing contaminants to again enter the second cavity at a modest rate that does not upset operating pressures in the melt passage.

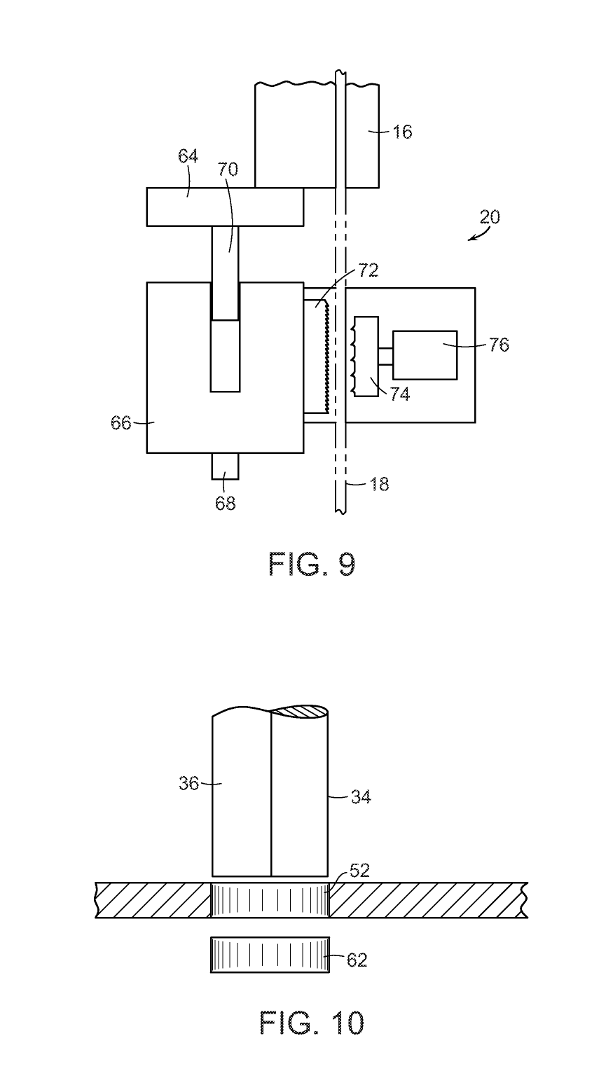

As an alternative to the above-described reciprocally operative ejector rod 54, and as shown in FIG. 10, the waste removal port 52 may simply be closed by a removable threaded plug 62. With the plug removed, access may be gained to the aligned second cavity 36 for manual removal of contaminants.

As shown in FIG. 9, the screen pulling mechanism 20 may comprise a base plate 64 secured to the screen exit guide 16. A cylinder block 66 is mounted for reciprocal movement on guide shafts 68 projecting from the base plate 64. Reciprocal movement of the cylinder block is occasioned by cooperation with a piston 70 projecting from the base plate 64. A fixed jaw 72 on the cylinder block 66 coacts with movable jaw 74 driven by a second piston/cylinder actuator 76.

In order to incrementally advance the screen filter, it is first gripped between the jaws 72, 74, and the cylinder block 66 is then advanced away from the base plate 64. The jaws 72, 74 then release the screen filter, allowing the cylinder block to be shifted back towards the base plate 64.

While embodiments of the invention have been shown and described in detail, it will now be apparent to those skilled in the art that many modifications and variations are possible, satisfying many or all of the objects of the invention, without departing from the spirit thereof as defined by the appended claims.

What is claimed is:

1. A screen changer for filtering a thermoplastic material heated to a flowable state, said apparatus comprising:
a filter head defining a melt passage for the heated thermoplastic material, and a guide channel having entry and exit sections arranged on opposite sides of said melt passage, said entry and exit sections being configured and arranged to direct a continuous screen filter along a path extending transversely across said melt passage from an entry side to an exit side of said filter head;
means for incrementally advancing said screen filter along said path;
an internal first cavity in said filter head on an upstream side of said filter screen and at a juncture of said melt passage and the exit section of said guide channel, said first cavity being positioned to receive contaminants accumulated on said screen filter; and
waste removal means for removing said contaminants from said first cavity.

2. The screen changer of claim 1 wherein said waste removal means comprises a cylindrical plug journalled for rotation in said filter head at a location adjacent to said first cavity; a second cavity in said plug; means for rotating said plug between a first position at which said second cavity communicates with and receives contaminants from said first cavity, and a second position at which said second cavity is isolated from said first cavity and aligned with an outlet in said filter head through which contaminants may be expelled from said second cavity.

3. The screen changer of claim 2 wherein said contaminants are expelled from said second cavity by an ejector rod mounted for reciprocal movement in said second cavity.

4. The screen changer of claim 2 further comprising a bed knife on an edge of said first cavity and a shear knife on an edge of said second cavity, said bed and shear knives being configured and arranged to coact in shearing contaminants trapped therebetween.

5. The screen changer as claimed in claim 1 wherein said means for accommodating removal of said contaminants from said second cavity comprises a waste removal port, and a plug closing said waste removal port, said plug being removable from said waste removal port to provide access to said second cavity for removal of contaminants therefrom.

6. The screen changer of claim 1 wherein said means for advancing said screen filter along said path comprises:
a clamp assembly for releasably gripping said screen filter at a first location on the exit side of said filter head; and first operating means for shifting said clamp assembly to a second location remote from said first location to thereby advance said screen filter along said path.

7. The screen changer of claim 6 wherein said clamp assembly comprises fixed and moveable jaws, and second operating means for advancing and retracting said movable jaw to grip and release said screen filter.

8. The apparatus of claim 6 wherein said clamp assembly is supported for reciprocal movement on a guide shafts projecting from said filter head in directions parallel to the exit path of said screen filter.

9. A method of filtering a thermoplastic material heated to a flowable state, said method comprising:
directing the heated thermoplastic material along a melt passage in a filter head;
providing a guide channel having entry and exit sections arranged on opposite sides of said melt passage, said entry and exit sections being configured to direct a continuous screen filter along a path extending transversely across said melt passage from an entry side to an exit side of said filter head;
advancing said screen filter along said path;
removing contaminants from the advancing screen filter into an internal first cavity in said filter head on an upstream side of said path and at a juncture of said melt passage and the exit section of said guide channel;
allowing said contaminants to progress from said first cavity into an adjacent second cavity; and
periodically removing contaminants from said first cavity.
